(19) United States
(12) Patent Application Publication
(10) Pub. No.: US 2004/0187157 A1
(43) Pub. Date: Sep. 23, 2004

(54) Multifunctional integrated multimedia viewer system

(76) Inventors: Yen-Hwong Chong, Penang (MY); Shih-Hsiung Weng, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/391,385

(22) Filed: Mar. 18, 2003

(51) Int. Cl. H04N 7/173

(52) U.S. Cl. 725/86; 725/88

(57) ABSTRACT

A multifunctional integrated multimedia viewer system is proposed, which is characterized by the integration of an assortment of media processing functions, including a digital photo browsing function, an audio playback function, a video playback function, a video/audio recording function, an earth location identifying function, and a TV display function, all in one single device unit, so that the user can enjoy these media processing functions all from one single device unit without having to purchase a number of devices. Moreover, the proposed multimedia viewer system also provides an assortment of interfaces, including a wireless interface, an AV I/O interface, a USB interface, and an external storage interface, which allow the user to further expand the media processing functionality.

### BACKGROUND OF THE INVENTION

1. Field of the Invention

This invention relates to multimedia technology, and more particularly, to a multifunctional integrated multimedia viewer system, which is capable of providing an assortment of media processing functions, including a digital photo browsing function, an audio playback function, a video playback function, a video/audio recording function, a navigation function, and a TV reception function, and which is further capable of being externally connected various kinds of media processing units, such as printer, storage unit, CD/DVD player, CD-RW unit, digital still camera (DSC), camcorder, mobile phone, TV tuner, PC unit, and so on, for the purpose of expanding its media processing functionality.

2. Description of Related Art

On the market of multimedia applications, there are various kinds of standalone media processing devices, such as digital photo browsers, MPEG players, MP3 players, VCD/DVD players, digital still cameras (DSC), camcorders, MMV (multimedia viewer), PSV (photo storage viewer), and so on. These media processing devices allow the user to view digital photos, MPEG videos, VCD/DVD programs, and listen to MP3 audio, as well as produce and permanently store digital photos, video programs, and audio programs.

One drawback to the abovementioned media processing devices, however, is that they are typically capable of providing only one media processing function; i.e., a digital photo browser is only capable of displaying digital photos, an MPEG player is only capable of displaying MPEG programs, an MP3 player is only capable of playing MP3 programs, and so forth. Therefore, if a user wants to view digital photos, MPEG programs, and listen to MP3 programs, the user needs to purchase the respective different kinds of devices that provide these media processing functions respectively. Undoubtedly, this practice is quite inconvenient and costly for the user. There exists therefore a need for a multifunctional integrated multimedia viewer system that can provide an assortment of media processing functions in one single device.

### SUMMARY OF THE INVENTION

It is therefore an objective of this invention to provide a multifunctional integrated multimedia viewer system, which is capable of providing an assortment of media processing functions in one single device.

It is another objective of this invention to provide a multifunctional integrated multimedia viewer system which is capable of being externally connected to various kinds of multimedia processing units for the purpose of expanding its media processing functionality.

The multifunctional integrated multimedia viewer system according to the invention is characterized by the integration of an assortment of media processing functions, including a digital photo browsing function, an audio playback function, a video playback function, a video/audio recording function, an earth location identifying function, and a TV display function, all in one single device unit, so that the user can enjoy these media processing functions all from one single device unit without having to purchase a number of devices.

Moreover, the multifunctional integrated multimedia viewer system of the invention also provides an assortment of interfaces, including a wireless interface, an AV I/O interface, a USB interface, and an external storage interface, which allow the user to further expand the media processing functionality. The multifunctional integrated multimedia viewer system of the invention is therefore very versatile and more advantageous to use than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic block diagram showing the internal architecture of the multifunctional integrated multimedia viewer system according to the invention; and

FIG. 2 is a schematic diagram showing the various external connecting capabilities of the multifunctional integrated multimedia viewer system according to the invention.

### DETAILED DESCRIPTION OF PREFERRED EMBODIMENTS

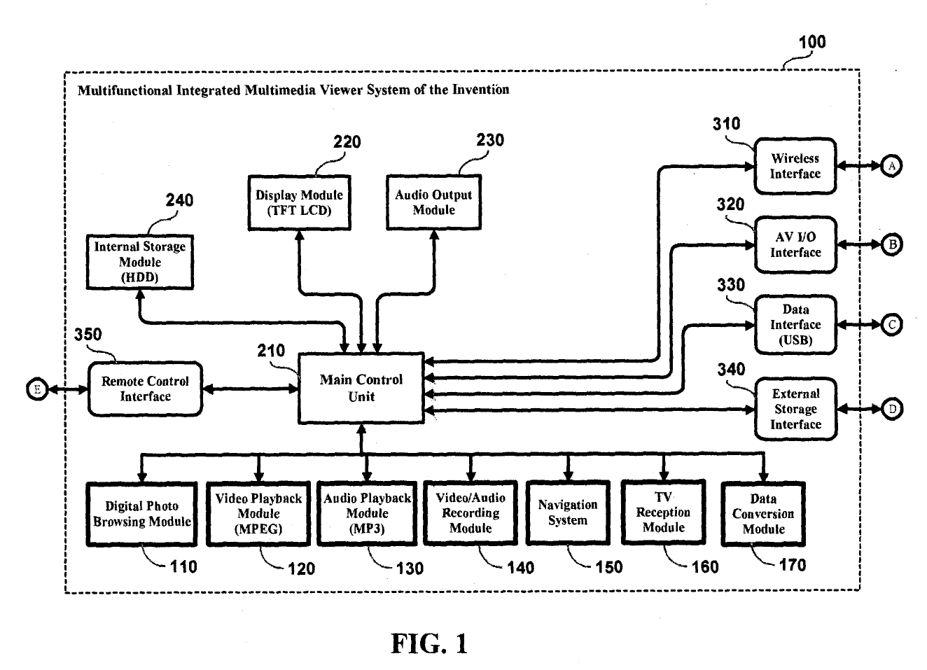

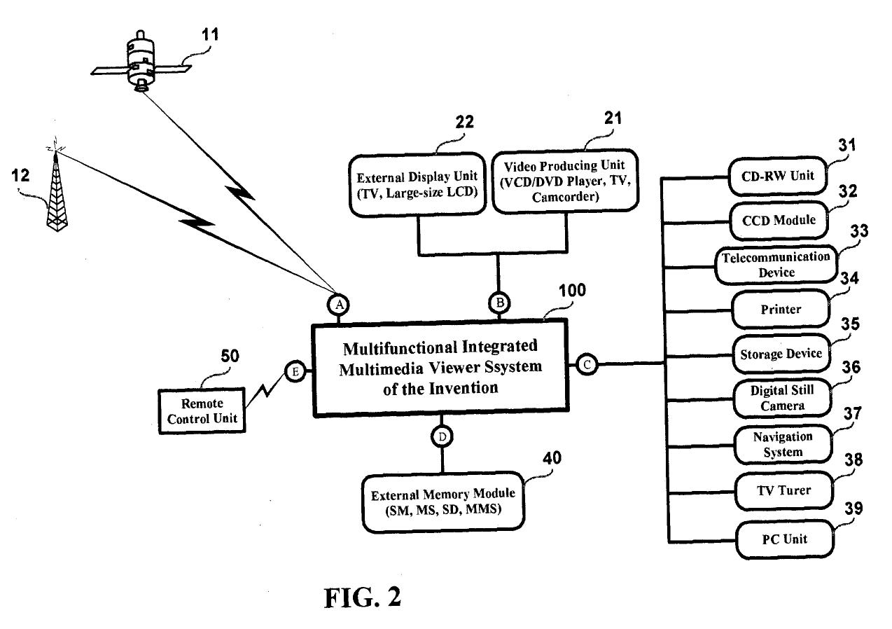

FIG. 1 is a schematic diagram showing the internal architecture of the multifunctional integrated multimedia viewer system according to the invention (as the part enclosed in the dotted box indicated by the reference numeral 100), while FIG. 2 is a schematic diagram showing the various external connecting capabilities of the multimedia viewer system of the invention 100. The multifunctional integrated multimedia viewer system of the invention 100 is capable of providing the following media processing functions: a digital photo browsing function, an audio playback function, a video playback function, a video/audio recording function, a navigation function, and a TV reception function.

As shown in FIG. 1, the multifunctional integrated multimedia viewer system of the invention 100 comprises: a digital photo browsing module 110, a video playback module 120, an audio playback module 130, a video/audio recording module 140, a navigation module 150, a TV reception module 160, a data conversion module, 170, a main control unit 210, a display module 220, an audio output module 230, an internal storage module 240, a wireless interface 310, an AV I/O (audio/video input/output) interface 320, and a data interface 330; and can be further optionally include an external storage interface 340 and a remote control interface 350.

The digital photo browsing module 110 is capable of providing a digital photo browsing function under control by the main control unit 210 for displaying digital photos on the display module 220 to allow the user to view digital photos using the multimedia viewer system of the invention 100.

The video playback module 120 is, for example, an MPEG-compliant video playback module, which is capable of providing a video playback function under control by the main control unit 210 for displaying MPEG files on the TFT LCD display module 220, with the audio contents of the MPEG files being reproduced through the audio output module 230 into natural sound, for the user to enjoy the viewing of MPEG video programs using the multimedia viewer system of the invention 100.

The audio playback module 130 is, for example, an MP3-compliant audio playback module, which is capable of providing an audio playback function under control by the main control unit 210 for reproducing MP3 files into natural sound through the audio output module 230 for the user to enjoy the listening of MP3 audio using the multimedia viewer system of the invention 100.

The video/audio recording module 140 is capable of providing a video/audio recording function under control by the main control unit 210 for recording a video/audio stream that is received via the AV I/O interface 320 from an externally-linked video/audio producing unit 21 (shown in FIG. 2), such as a VCD/DVD player, a TV unit, a camcorder, and the like, and store the video/audio stream into the internal storage module 240. Afterwards, the recorded video/audio can be retrieved by the video playback module 120 to be visibly displayed on the display module 220 and audibly reproduced through the audio output module 230.

The navigation module 150 is capable of providing a navigation function for the user to identify his/her current earth location. When this function is used, the navigation module 150 is activated and linked via the wireless interface 310 to an earth location identifying system, such as a GPS (Global Positioning System) based satellite 11 (shown in FIG. 2), and inquire the GPS-based satellite 11 for earth location data. In response, the GPS-based satellite 11 will send back related earth location data, typically a digitized map, to the multimedia viewer system of the invention 100 to be displayed on the display module 220 for the user to learn his/her current earth location.

The TV reception module 160 is capable of receiving aired TV programs via the wireless interface 310 directly from a TV broadcast station 12 or indirectly via a TV relay satellite (not shown) from the TV broadcast station 12, and display the received TV programs on the display module 220 for the user to enjoy the viewing of TV programs on the multimedia viewer system of the invention 100.

The Data Conversion Module 170 is coupled to the Main Control Unit 210 mainly for converting data such as JPEG file, MP3 file or MPEG file stored in the Internal Storage Module 240 to a telecommunication compliance data format, such as XML (Extensible Markup Language) format for WAP (Wireless Application Protocol) based mobile phone application, to allow the data to be able to be sent out to another remote device (not shown) through an external telecommunication device 33 which is connected to the Data Interface (USB) 330. The Data Conversion Module 170 is also able to de-convert back the data sent by external Telecommunication device 33 via the data interface (USB) 330 to the source format which the data is received by the external Telecommunication) device from another distance/remote device.

The main control unit 210 is responsive for controlling the operations of the digital photo browsing module 110, the video playback module 120, the audio playback module 130, the video/audio recording module 140, the navigation module 150, and the TV reception module 160, as well as controlling the data exchange and transfer between these modules 110, 120, 130, 140, 150, 160 and the display module 220, the audio output module 230, the internal storage module 240, and the various interfaces 310, 320, 330, 340, 350.

The display module 220 is, for example, a color TFT LCD (Thin Film Transistor Liquid Crystal Display) module, which is capable of displaying graphic user interface, digital photos, MPEG video, GPS data, and TV programs thereon.

The audio output module 230 is used to convert digitized audio into natural sound, and which can include internal loudspeaker and output earphone jack (not shown), so that the user can choose to reproduced audio directly through the internal loudspeaker, or to be transferred to an externally-connected earphone (not shown).

The internal storage module 240 is a mass storage unit, such as a hard disk drive (ODD) or a flash memory module, or a combination thereof, which is used to store the binary data of digital photos, MPEG video files, and MP3 audio files in addition to operating system programs of the multimedia viewer system of the invention 100.

To allow the user to expand media processing functionality, the multimedia viewer system of the invention 100 provides a number of interfaces, including a wireless interface 310, an AV I/O (audio/video input/output) interface 320, a data interface 330, and an external storage interface 340.

The wireless interface 310 is internally coupled to the main control unit 210 and is used by the navigation module 150 and the TV reception module 160, for the navigation module 150 to be wireless linked to a GPS-based satellite 11 or for the TV reception module 160 to receive aired TV programs from a TV broadcast station 12.

The AV I/O interface 320 is, for example, a PAL/NTSC-compliant AV I/O interface, which allows the multimedia viewer system of the invention 100 to be externally connected to a video/audio producing unit 21 (such as a VCD/DVD player, a TV unit, a camcorder, or the like) or to an external display unit 22 (such as a TV unit, a large-size LCD unit, a projector, or the like). When connected to video/audio producing unit 21, it allows the multimedia viewer system of the invention 100 to receive an output video/audio stream from the video/audio producing unit 21 for the video playback module 120 to display this externally-produced video/audio on the TFT LCD display module 220, or for the video/audio recording module 140 to record it into the internal storage module 240. On the other hand, when connected to external display unit 22, it allows the multimedia viewer system of the invention 100 to display digital photos or video on the external display unit 22 instead of the internal display module 220.

The data interface 330 is, for example, a USB (Universal Serial Bus) compliant data interface, which allows the multimedia viewer system of the invention 100 to be externally connected to various USB-capable media processing units, such as a CD/DVD-RW unit 31, a CCD (Charge Coupled Device) unit 32, a telecommunication device 33 (such as a mobile phone), a printer 34, a storage device 35, a digital still camera (DSC) 36, a navigation system 37, a TV tuner 38, and a PC unit 39; to name just a few. This feature allows the multimedia viewer system of the invention 100 to exchange data with these media processing units 31, 32, 33, 34, 35, 36, 37, 38, 39 to expand its media processing functionality.

The external storage interface 340 is, for example, a flash memory coupling interface, such as a 4-in-1 compact flash memory adapter, which can be externally connected to various types of flash memory modules, such as SM (Smart Media) card, MS (Memory Stick) card, SD (Secure Digital) card, MMC (MultiMedia Card); to name just a few, for the purpose of externally expanding the data storage capacity of the multimedia viewer system of the invention 100 or download digital photos, MPEG video files, and MP3 audio files from these external flash memory modules.

The remote control interface 350 is, for example, an infrared (IR) based remote control interface, which is capable of externally receiving wireless control signals from a remote control unit 50 for the purpose of allowing the user to remotely controlling the operations of the multimedia viewer system of the invention 100 through the remote control unit 50.

In operation, the multifunctional integrated multimedia viewer system of the invention 100 provides the user with an assortment of media processing functions, including: browsing digital photos, viewing MPEG video, listening to MP3 audio, recording video/audio, identifying current earth location, and watching aired or cabled TV programs.

In the operation mode of browsing digital photos, the user can prestore a collection of digital photos in the internal storage module 240 that are downloaded from, for example, an external CD/DVD unit 31, an external storage device 35, an external digital still camera 36, or an external PC unit 39 that are linked via the USB interface 330, or from an external flash memory module 40 that is linked to the external storage interface 340. Afterwards, the user can activate the digital photo browsing module 110 to display these digital photos on the color TFT LCD display module 220 or on an external display unit 22, such as a TV or a large-size LCD, linked to the AV I/O interface 320.

In the operation mode of viewing MPEG video, the user can prestore a collection of MPEG video files in the internal storage module 240 that are downloaded from, for example, an external CD/DVD unit 31, an external storage device 35, or an external PC unit 39 that are linked via the USB interface 330, or from a camcorder that is linked via the AV I/O interface 320. Afterwards, the user can activate the video playback module 120 to display these MPEG video files on the color TFT LCD display module 220 or on an external display unit 22, such as a TV or a large-size LCD, linked to the AV I/O interface 320.

In the operation mode of listening to MP3 audio, the user can prestore a collection of MP3 audio files in the internal storage module 240 that are downloaded from, for example, an external CD/DVD unit 31, an external storage device 35, or an external PC unit 39 that are linked via the USB interface 330. Afterwards, the user can activate the audio playback module 130 to reproduce these MP3 audio files into natural sound through the audio output module 230.

In the operation mode of recording video/audio, the user can connect an external video/audio producing unit 21 (such as a VCD/DVD player, a TV, or a camcorder) via the AV I/O interface 320, and then activate the video/audio recording module 140 to record the output video/audio stream from the video/audio producing unit 21 and store the recorded video/audio data into the internal storage module 240 so that thereafter the user can activate the video playback module 120 to reproduce these recorded video/audio files.

In the operation mode of identifying current earth location, the navigation module 150 is activated to link via the wireless interface 310 to a GPS-based satellite 11 and then inquire the GPS-based satellite 11 for the user's current earth location. In response, the GPS-based satellite 11 will send back a pack of earth location data indicative of the user's current earth location (typically a digitized map), and the earth location data will be received by the wireless interface 310 and transferred to the navigation module 150 to be displayed on display module 220 for the user to learn his/her current earth location.

In the operation mode of receiving TV programs, the user can watch aired TV programs that is received via the wireless interface 310 from a TV broadcast station 12, or cabled TV programs by connecting the AV I/O interface 320 to a cable TV line (not shown). The TV reception module 160 is activated to receive these TV programs and dis-display the received TV programs on the color TFT LCD display module 220 for the user to watch the received TV programs.

In the operation of sending data to distance/remote location, the user can send the selected internal file, for example a JPEG file, to another device such as a VOIP (Voice over Internet Protocol) unit through a connected external Telecommunication device 33 such as a mobile phone. The Data Conversion Module 170 converts the JPEG file to a telecommunication compliance format such as XML format for WAP-based mobile phone application, the data is sent to the mobile phone 33 via the connected Data Interface(USB) 330 then is transmitted via VOIP by the mobile phone. When receiving data from a distance/remote location, such as from a PC Server located at office, an external telecommunication device such as a VOIP at home is used as communication interface to received data from the PC Server via the Data Interface USB(330). The received data is sent to the Data Conversion Module 170 for de-converting back to source format. The de-converted data is displayed on Display Module 220 or stored in the Internal Storage Module 240

Furthermore, the provision of the USB-based data interface 330 allows the user to externally couple the multimedia viewer system of the invention 100 to various kinds of media processing units, such as CD/DVD-RW unit 31, CCD (Charge Coupled Device) unit 32, telecommunication device 33, printer 34, storage device 35, digital still camera (DSC) 36, navigation system 37, TV tuner 38, and PC unit 39, to name just a few, for the purpose of expanding the media processing functionality of the multimedia viewer system of the invention 100. For example, the user can couple the CCD unit 32 to turn the multimedia viewer system of the invention 100 into a digital camera with viewing and mass storage capability; or couple the telecommunication device 33 to allow the multimedia viewer system of the invention 100 to wireless transmit digital photos, MPEG files, or MP3 files to his/her friends; or couple the printer 34 to print out digital photos stored in the multimedia viewer system of the invention 100; and so forth. Beside these, various other kinds of media processing units can be coupled.

In addition, the multimedia viewer system of the invention 100 allows the user to remotely control its operations through an IR-based remote control unit 50. The remote control unit 50 can emit wireless control signals against the multimedia viewer system of the invention 100, and these wireless control signals will be received by the remote control interface 350 and forwarded to the main control unit 210 to control the operations of the multimedia viewer system of the invention 100.

In conclusion, the invention provides a multifunctional integrated multimedia viewer system, which is characterized by the integration of an assortment of media processing functions, including a digital photo browsing function, an audio playback function, a video playback function, a video/audio recording function, an earth location identifying function, and a TV display function, all in one single device unit, so that the user can enjoy these media processing functions all from one single device unit without having to purchase a number of devices. Moreover, the multifunctional integrated multimedia viewer system of the invention also provides an assortment of interfaces, including a wireless interface, an AV I/O interface, a USB interface, and an external storage interface, which allow the user to further expand the media processing functionality. The multifunctional integrated multimedia viewer system of the invention is therefore very versatile and more advantageous to use than prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A multifunctional integrated multimedia viewer system, which comprises:
a digital photo browsing module, which is capable of providing a digital photo browsing function;
a video playback module, which is capable of providing a video playback function;
an audio playback module, which is capable of providing an audio playback function;
a video/audio recording module, which is capable of providing a video/audio recording function;
a navigation module, which is capable of providing a navigation function;
a TV reception module, which is capable of providing a TV reproduction function;
a main control unit, which is used to control the operations of the digital photo browsing module, the video playback module, the audio playback module, the video/audio recording module, the navigation module, and the TV reception module in response to user-input commands;
an internal storage module, which is used to store digital photos, video files, and audio files for processing by the digital photo browsing module, the video playback module, the audio playback module, and store video/audio streams recorded by the video/audio recording module;
a display module, which is capable of displaying digital photos, video, images, and graphics from the digital photo browsing module, the video playback module, the navigation module, or the TV reception module;
an audio output module, which is capable of reproducing the digital audio data from the video playback module, the audio playback module, or the TV reception module into natural sound;
a wireless interface, which is internally coupled to the navigation module and the TV reception module, for establishing a wireless link between the navigation module and a global positioning system or establishing a wireless link between the TV reception module and a TV broadcast station;
an AV I/O interface, which is capable of being externally coupled to an external video/audio producing unit or an external display unit, to allow video/audio data transfer between the externally connected unit and the video/audio recording module or the video playback module;
a data interface, which is under control by the main control unit for external connection to one or more external media processing units to expand the media processing functionality of the multifunctional integrated multimedia viewer system; and
a data conversion module which is internally coupled to the data interface module to convert the data to a telecommunication compliance format before sending, the data to an external telecommunication device via the data interface module, and de-convert the received data which is received via data interface module from an external telecommunication device to a source format.

2. The multifunctional integrated multimedia viewer system of claim 1, further comprising:
an external storage interface, which is under control by the main control unit, for connection to an external storage device.

3. The multifunctional integrated multimedia viewer system of claim 1, further comprising:
a remote control interface, which is internally coupled to the main control unit and externally linkable to a remote control unit, for remotely controlling the operations of the multifunctional integrated multimedia viewer system.

4. The multifunctional integrated multimedia viewer system of claim 1, wherein the video playback module is MPEG-compliant video playback module.

5. The multifunctional integrated multimedia viewer system of claim 1, wherein the audio playback module is an MP3-compliant audio playback module.

6. The multifunctional integrated multimedia viewer system of claim 1, wherein the display module is a color TFT LCD module.

7. The multifunctional integrated multimedia viewer system of claim 1, wherein the AV input/output interface is PAL/NTSC compliant.

8. The multifunctional integrated multimedia viewer system of claim 1, wherein the data interface is a USB-compliant data interface.

9. The multifunctional integrated multimedia viewer system of claim 1, wherein the external storage interface includes a 4-in-1 flash memory adapter.

10. The multifunctional integrated multimedia viewer system of claim 1, wherein the remote control interface is an JR-based remote control interface.

11. The multifunctional integrated multimedia viewer system of claim 1, wherein the telecommunication compliance format is XML format for WAP mobile phone.

12. A multifunctional integrated multimedia viewer system, which comprises:
a digital photo browsing module, which is capable of providing a digital photo browsing function;
an MPEG video playback module, which is capable of providing a video playback function;
an MP3 audio playback module, which is capable of providing an audio playback function;
a video/audio recording module, which is capable of providing a video/audio recording function;
a navigation module, which is capable of providing a navigation function;
a TV reception module, which is capable of providing a TV reproduction function;
a data conversion module, which is internally coupled to the data interface module to convert the data to a telecommunication compliance format before sending the data to an external telecommunication device via the data interface module, and de-convert the received data which is received via data interface module from an external telecommunication device to a source format;
a main control unit, which is used to control the operations of the digital photo browsing module, the video playback module, the audio playback module, the video/audio recording module, the navigation module, and the TV reception module in response to user-input commands;
an internal storage module, which is used to store digital photos, video files, and audio files for processing by the digital photo browsing module, the video playback mod-module, the audio playback module, and store video/audio streams recorded by the video/audio recording module;
a display module, which is capable of displaying digital photos, video, images, and graphics from the digital photo browsing module, the video playback module, the navigation module, or the TV reception module;
an audio output module, which is capable of reproducing the digital audio data from the video playback module, the audio playback module, or the TV reception module into natural sound;
a wireless interface, which is internally coupled to the navigation module and the TV reception module, for establishing a wireless link between the navigation module and a global positioning system or establishing a wireless link between the TV reception module and a TV broadcast station;
an AV I/O interface, which is capable of being externally coupled to an external video/audio producing unit or an external display unit, to allow video/audio data transfer between the externally connected unit and the video/audio recording module or the video playback module;
a USB-based data interface, which is under control by the main control unit for external connection to one or more external media processing units to expand the media processing functionality of the multifunctional integrated multimedia viewer system;
an external storage interface, which is under control by the main control unit, for connection to an external storage device; and
a remote control interface, which is internally coupled to the main control unit and externally linkable to a remote control unit, for remotely controlling the operations of the multifunctional integrated multimedia viewer system.

13. The multifunctional integrated multimedia viewer system of claim 12, wherein the display module is a color TFT LCD module.

14. The multifunctional integrated multimedia viewer system of claim 12, wherein the AV input/output interface is PAL/NTSC compliant.

15. The multifunctional integrated multimedia viewer system of claim 12, wherein the external storage interface includes a 4-in-1 flash memory adapter.

16. The multifunctional integrated multimedia viewer system of claim 12, wherein the remote control interface is an IR-based remote control interface.

17. The multifunctional integrated multimedia viewer system of claim 12, wherein the telecommunication compliance format is XML format for WAP mobile phone.
